(19) United States
(12) Patent Application Publication
(10) Pub. No.: US 2020/0183227 A1
(43) Pub. Date: Jun. 11, 2020

(54) LIQUID CRYSTAL DISPLAY DEVICE

(71) Applicant: Samsung Display Co., Ltd., Yongin-si (KR)

(72) Inventors: Donghee LEE, Hwaseong-si (KR); Baek Hee LEE, Seoul (KR)

(21) Appl. No.: 16/575,270

(22) Filed: Sep. 18, 2019

(30) Foreign Application Priority Data
Dec. 7, 2018 (KR) 10-2018-0156962

(51) Int. Cl. G02F 1/1335; G02F 1/017

(52) U.S. Cl. CPC G02F 1/133528; G02F 1/017; G02F 2001/133548; G02F 2001/01791; G02F 1/133514

(57) ABSTRACT

A liquid crystal display device includes a light source member including a plurality of light emitting element packages, and a liquid crystal display panel disposed on an upper side of the light source member. The liquid crystal display panel includes a first substrate adjacent to the light source member which includes a first base substrate, a color conversion layer with a quantum dot disposed on an upper side of the first base substrate, and a first polarizing layer disposed on an upper side of the first base substrate. The liquid crystal display panel includes a second substrate facing the first substrate which includes a second base substrate, a second polarizing layer disposed on an upper side of a liquid crystal layer, and a circuit layer disposed on a lower side of the second base substrate. The liquid crystal layer is disposed between the first substrate and the second substrate.

### CROSS-REFERENCE TO RELATED APPLICATIONS

This application claims priority from and the benefit of Korean Patent Application No. 10-2018-0156962, filed on Dec. 7, 2018, which is hereby incorporated by reference for all purposes as if fully set forth herein.

### BACKGROUND

### Field

Exemplary implementations of the invention relate generally to liquid crystal display device.

### Discussion of the Background

The present disclosure herein relates to a liquid crystal display device, and more particularly, to a liquid crystal display device having a color conversion layer including quantum dots.

Various types of display devices are used to provide image information, and in the case of a liquid crystal display, due to its advantages of low power consumption, it is widely used in large display devices and portable display devices. Meanwhile, in the case of a liquid crystal display device, in order to increase the light efficiency and improve the color reproducibility, various kinds of optical members are added to the backlight unit. In recent years, there is an increasing demand for a thin display device having a thin thickness in addition to excellent optical characteristics but when various optical members are added to improve the display quality of the liquid crystal display, there is a problem that the thickness of the entire display device is increased.

The above information disclosed in this Background section is only for understanding of the background of the inventive concepts, and, therefore, it may contain information that does not constitute prior art.

### SUMMARY

Devices constructed according to exemplary implementations of the invention may provide a liquid crystal display device having a reduced thickness while maintaining improved optical characteristics and particularly, a liquid crystal display device which integrates a color conversion layer and a liquid crystal display panel substrate to exhibit excellent color reproducibility, high luminance, and improved reliability.

Additional features of the inventive concepts will be set forth in the description which follows, and in part will be apparent from the description, or may be learned by practice of the inventive concepts.

According to one or more embodiments of the invention, a liquid crystal display device includes: a light source member including a plurality of light emitting element packages; and a liquid crystal display panel disposed on an upper side of the light source member, the liquid crystal display panel comprising: a first substrate adjacent to the light source member, the first substrate comprising: a first base substrate; a color conversion layer disposed on an upper side of the first base substrate and comprising a quantum dot; and a first polarizing layer disposed on an upper side of the first base substrate; and a second substrate facing the first substrate, the second substrate comprising: a second base substrate; a second polarizing layer disposed on an upper side of a liquid crystal layer; and a circuit layer disposed on a lower side of the second base substrate; and the liquid crystal layer disposed between the first substrate and the second substrate.

The second substrate may further include a color filter layer disposed between the liquid crystal layer and the circuit layer, the color filter layer including a plurality of filter parts for transmitting light of different wavelength ranges.

The second substrate may further include a light blocking part disposed overlapping a boundary of adjacent filter parts among the filter parts.

The first substrate may further include a light blocking part overlapping a boundary of adjacent filter parts among the filter parts and disposed on the first polarizing layer.

The first substrate may further include a color filter layer disposed between the color conversion layer and the liquid crystal layer.

The liquid crystal display device may further include a barrier layer disposed on at least one of an upper surface and a lower surface of the color conversion layer.

The first substrate may be disposed on one of an upper side and a lower side of the first base substrate, and the first substrate may further include a scattering layer including a scattering particle of at least one of TiO₂, SiO₂, ZnO, Al₂O₃, BaSO₄, CaCO₃, or ZrO₂.

The first substrate may further include a light condensing layer disposed on an upper side of the color conversion layer.

The light condensing layer may include: a condensing pattern part including a protruding pattern protruding toward a direction of the liquid crystal layer; and a low reflective part disposed on the condensing pattern part to cover the protruding pattern.

The first substrate may be disposed on one of an upper side and a lower side of the first base substrate, and the first substrate may further include a filter layer configured to transmit blue light and reflect red light and green light.

The filter layer may include: a plurality of first insulating films and a plurality of second insulating films, wherein the plurality of first insulating films and the plurality of second insulating films are alternately arranged with each other, and wherein the plurality of first insulating films and the plurality of second insulating films have a different refractive index from each other.

A refractive index of the first insulating films may be equal to or greater than 1.4 and equal to or less than 1.6, and a refractive index of the second insulating films may be equal to or greater than 1.9 and equal to or less than 2.1.

The color conversion layer may be disposed directly on an upper surface of the first base substrate.

The first polarizing layer may be a wire grid polarizer.

At least one of the plurality of light emitting element packages may include a light emitting element configured to emit blue light, wherein the color conversion layer may include a first quantum dot configured to emit green light in response to being excited by the blue light and a second quantum dot configured to emit red light in response to being excited by the blue light.

At least one of the plurality of light emitting element packages may further include a light emitting element configured to emit blue light and a sealing part covering the light emitting element and including at least one phosphor,

The sealing part may include a first phosphor configured to emit red light in response to being excited by the blue light, and the color conversion layer may include a first quantum dot configured to emit green light in response to being excited by the blue light to emit green light.

The sealing part may include a second phosphor configured to emit green light in response to being excited by the blue light, and the color conversion layer may include a second quantum dot configured to emit red light in response to being excited by the blue light.

According to one or more embodiments of the invention, a liquid crystal display device includes: a liquid crystal display panel including a first substrate, a second substrate facing the first substrate, and a liquid crystal layer disposed between the first substrate and the second substrate; and a light source member disposed on a lower side of the liquid crystal display panel, the light source member configured to provide first color light to the liquid crystal display panel, wherein the first substrate includes: a first base substrate; a color conversion layer disposed on an upper side of the first base substrate and including a quantum dot; a first polarizing layer disposed on an upper side of the color conversion layer; and a scattering layer disposed on an upper side or a lower side of the first base substrate, and wherein the second substrate includes: a second base substrate; a circuit layer disposed on a lower side of the second base substrate; a color filter layer disposed between the liquid crystal layer and the circuit layer; and a second polarizing layer disposed on an upper side of the second base substrate.

The first color light may have a center wavelength of 420 nm to 470 nm, wherein the color conversion layer may include: a first quantum dot configured to emit second color light having a center wavelength of 520 nm to 570 nm in response to being excited by the first color light; and a second quantum dot configured to emit a third color light of a center wavelength of 620 nm to 670 nm in response to being excited by the first color light.

It is to be understood that both the foregoing general description and the following detailed description are exemplary and explanatory and are intended to provide further explanation of the invention as claimed.

### BRIEF DESCRIPTION OF THE FIGURES

The accompanying drawings are included to provide a further understanding of the inventive concepts, and are incorporated in and constitute a part of this specification. The drawings illustrate exemplary embodiments of the inventive concepts and, together with the description, serve to explain principles of the inventive concepts.

FIG. 1 is a perspective view of a display device of an exemplary embodiment.

FIG. 2 is a cross-sectional view corresponding to a sectional line I-I′ in a liquid crystal display device of an exemplary embodiment shown in FIG. 1.

FIGS. 3A and 3B are cross-sectional views showing an exemplary embodiment of a light emitting unit included in a light source member.

FIG. 4 is a cross-sectional view of a color conversion layer according to an exemplary embodiment.

FIG. 5A is a plan view of a pixel included in a liquid crystal display device of an exemplary embodiment.

FIG. 5B is a plan view of a pixel included in a liquid crystal display device of an exemplary embodiment.

FIG. 6 is a cross-sectional view of part corresponding to a sectional line II-IF of FIG. 5A.

FIGS. 7, 8, and 9 are cross-sectional views showing part of a liquid crystal display device of each exemplary embodiment.

FIG. 10 is a cross-sectional view of a filter layer according to an exemplary embodiment.

FIGS. 11 and 12 are cross-sectional views showing part of a liquid crystal display device of each exemplary embodiment.

FIGS. 13 and 14 are cross-sectional views showing a liquid crystal display device of each exemplary embodiment.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, a DR1-axis, a DR2-axis, and a DR3-axis are not limited to three axes of a rectangular coordinate system, such as the x, y, and z-axes, and may be interpreted in a broader sense. For example, the DR1-axis, the DR2-axis, and the DR3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Hereinafter, a liquid crystal display device according to an exemplary embodiment of the inventive concepts will be described with reference to the drawings.

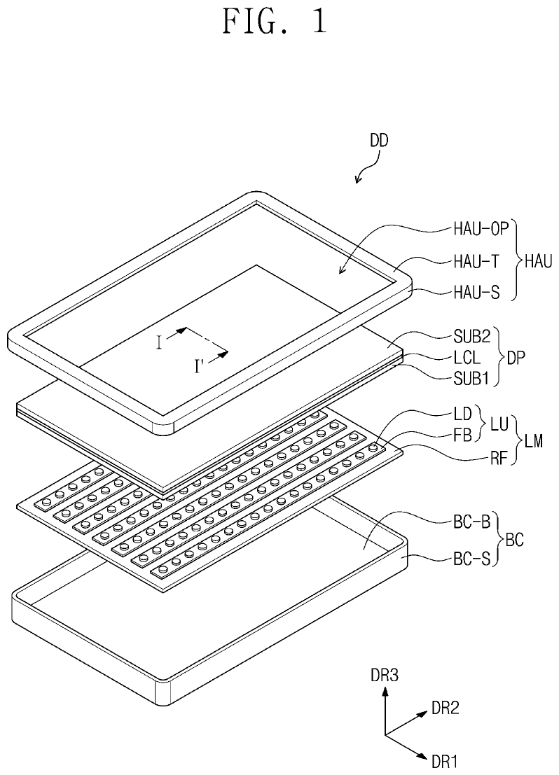

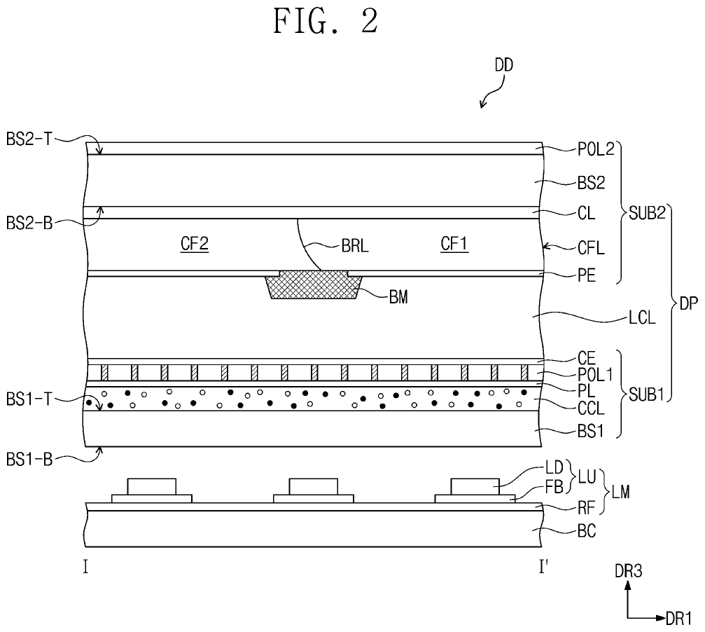

FIG. 1 is an exploded perspective view of a liquid crystal display device according to an exemplary embodiment. FIG. 2 is a cross-sectional view showing a liquid crystal display device of an exemplary embodiment. FIG. 2 is a cross-sectional view showing a portion corresponding to a sectional line I-I′ in the liquid crystal display device of the exemplary embodiment shown in FIG. 1.

Referring to FIGS. 1 and 2, the liquid crystal display device DD of one embodiment may include a light source member LM and a liquid crystal display panel DP disposed on the light source member LM. The liquid crystal display panel DP may overlap the light source member LM. The liquid crystal display panel DP is disposed on the upper side of the light source member LM, and the liquid crystal display device DD of one embodiment may be one having a direct light source LM. In one embodiment, the liquid crystal display panel DP includes a first substrate SUB1 and a second substrate SUB2 facing each other, and may include a color conversion layer CCL on the first substrate SUB1 adjacent to the light source member LM.

Meanwhile, a first directional axis DR1, a second directional axis DR2, and a third directional axis DR3 are shown in FIG. 1, and the direction axes described herein are relative to each other. For convenience of description, in FIG. 1, the direction of the third directional axis DR3 may be defined as a direction in which the image is provided to the user. Further, the first directional axis DR1 and the second directional axis DR2 are orthogonal to each other, and the third directional axis DR3 may be a normal direction to a plane defined by the first directional axis DR1 and the second directional axis DR2.

The front surface (or upper surface, top surface) and the back surface (or lower surface, bottom surface) of each of members or units described below are separated by a third directional axis DR3. However, the first to third direction axes DR1, DR2, DR3 shown in this embodiment are merely illustrative. Hereinafter, the first to third directions are defined as the directions indicated by the first to third direction axes DR1, DR2, and DR3, respectively, and refer to the same reference numerals.

The liquid crystal display device DD of one embodiment may include a bottom cover BC. The bottom cover BC disposed below the light source member LM may be for housing the light source member LM and the liquid crystal display panel DP. The bottom cover BC may include a bottom part BC-B and sidewall parts BC-S bent and extending from the bottom part BC-B. The bottom cover BC may be made of metal or plastic.

A housing HAU may be disposed on the upper side of the liquid crystal display panel DP. In the liquid crystal display device DD of one exemplary embodiment, the bottom cover BC and the housing HAU are coupled to each other to accommodate the liquid crystal display panel DP and the light source member LM. The housing HAU may be made of metal or plastic.

The housing HAU may be disposed on the upper side of the liquid crystal display panel DP to cover the edge area of the liquid crystal display panel DP. The housing HAU may include an opening part HAU-OP where an image is provided. In one exemplary embodiment, the housing HAU may be a rectangular frame in a plane. The housing HAU may include a housing sidewall part HAU-S and a front part HAU-T bent from the housing sidewall part HAU-S. In one exemplary embodiment, the front part HAU-T may be omitted.

Meanwhile, in one exemplary embodiment, a mold member may further be provided between the bottom cover BC and the housing HAU. The mold member may support the liquid crystal display panel DP and the like so that the liquid crystal display panel DP is spaced apart from the light source member LM at a predetermined interval.

The light source member LM may be provided on the bottom part BC-B of the bottom cover BC. The light source member LM may include a plurality of light emitting units LU and a reflection plate RF. The light emitting units LU may be disposed in the upper part of the reflection plate RF. Each of the light emitting units LU may include a circuit board FB and a plurality of light emitting element packages LD mounted on the circuit board FB. The light emitting units LU may include a different number of light emitting element packages LD.

The light emitting element package LD may be one that receives an electrical signal from a circuit board FB to emit light. Although not shown separately in the drawings, the liquid crystal display DD of one exemplary embodiment may further include a circuit board for electrically connecting the light emitting units LU. A dimming circuit may be disposed on the circuit board. This dimming circuit may dim the light emitting units LU based on the control signal received from the central control circuit. The plurality of light emitting element packages LD may be simultaneously turned on or off, or independently turned on and off.

Although it is shown in FIG. 1 that the light emitting element packages LD are disposed at regular intervals, the exemplary embodiment is not limited thereto. The arrangement interval of the light emitting element packages LD may vary depending on the central area or the edge area of the liquid crystal display panel DP, and the like.

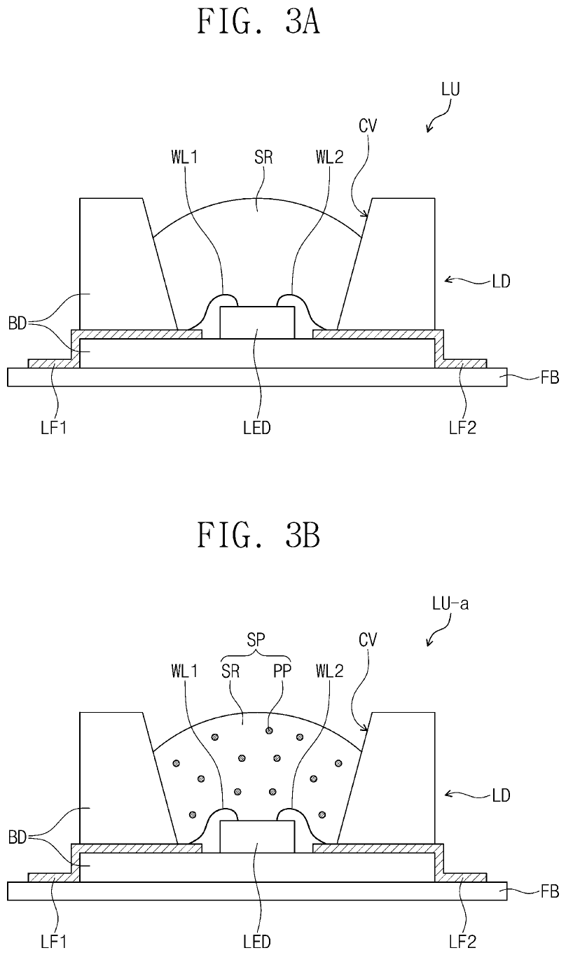

FIGS. 3A and 3B are cross-sectional views showing an exemplary embodiment of the light emitting units LU and LU-a. Referring to FIGS. 3A and 3B, a light emitting element package LD included in the light emitting units LU and LU-a includes a light emitting element LED, a pair of lead frames LF1 and LF2, and a body part BD.

The light emitting element LED generates light in response to a voltage supplied from the circuit board FB. The light emitting element LED has a structure in which an n-type semiconductor layer, an active layer, and a p-type semiconductor layer are sequentially stacked, and when a driving voltage is applied, electrons and holes may be recombined while moving and light may be generated.

The body part BD may mount a light emitting element LED and fix the first lead frame LF1 and the second lead frame LF2. The body part BD may be made of a material such as a polymer resin. In addition, the body part BD may have a cavity CV, and the cavity CV may be a space in which the light emitting element LED is mounted.

The light emitting element LED may be disposed in the cavity CV of the body part BD and a filling resin SR that surrounds and fills the light emitting element LED may be disposed in the cavity CV. The filling resin SR may serve to protect the light emitting element LED. As the filling resin SR, an epoxy resin, an acrylic resin, or the like may be used.

In addition, each of the first lead frame LF1 and the second lead frame LF2 may penetrate a part of the body part BD. In addition, the lead frames LF1 and LF2 exposed in the cavity CV and the light emitting element LED may be electrically connected by the connection wires WL1 and WL2.

According to the light emitting unit LU-a of an exemplary embodiment shown in FIG. 3B, the sealing part SP including the phosphor PP together with the filling resin SR may be disposed in the cavity CV. That is, as compared with the light emitting unit LU shown in FIG. 3A, the light emitting unit LU-a according to an exemplary embodiment shown in FIG. 3B differs in that it further includes the phosphor PP in the sealing part SP provided on the light emitting element LED. As the phosphor PP, a red phosphor, a yellow phosphor, or a green phosphor may be used, and the exemplary embodiment is not limited to this. Phosphor materials that may be excited by the light emitted from the light emitting element LED may be selectively included. In one exemplary embodiment, the light emitting element LED may be one that emits blue light. Accordingly, the light emitting unit LU of FIG. 3A, which does not include a separate phosphor, may emit blue light. Meanwhile, the light emitting unit LU-a according to an exemplary embodiment shown in FIG. 3B may include a light emitting element LED that emits blue light and a phosphor PP that is excited by blue light to emits red light. That is, the phosphor PP may be a red phosphor. In this case, the light emitting material package LD may provide the blue light and the red light to the liquid crystal display panel DP.

In another exemplary embodiment, the light emitting unit LU-a may include a light emitting element LED that emits blue light and a green phosphor that is excited by blue light to emit green light. In this case, the light emitting unit LU-a may provide blue light and green light to the liquid crystal display panel DP.

The shape of the light emitting unit LU is not limited to that shown in FIG. 3A or 3B, and for example, the filling resin SR and the like may be disposed to surround the light emitting element LED in a lens shape. In this case, the light emitting element package LD may not include a separate body part BD.

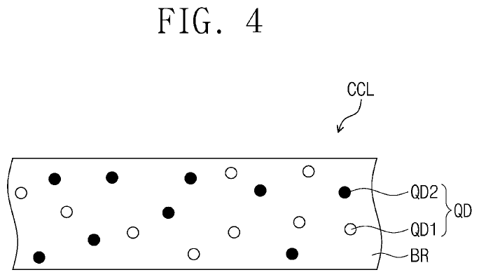

Light provided in the light emitting units LU and LU-a may be provided to the liquid crystal layer LCL (see FIG. 2) as white light through the color conversion layer CCL (see FIG. 2) described later. In other words, by a combination of the light emitting element LED of the light source member LM and the quantum dot QD (see FIG. 4) included in the color conversion layer CCL (see FIG. 2) and various combinations of the light emitting element LED and the phosphor PP included in the light emitting unit LU-a, and the quantum dot QD (see FIG. 4) included in the color conversion layer CCL (see FIG. 2), the light provided in the light source member LM (see FIG. 2) may be finally provided to the liquid crystal layer LCL (FIG. 2) as white light.

Referring again to FIG. 2, the light source member LM may further include a reflection plate RF. The reflection plate RF may be disposed on the bottom part BC-B of the bottom cover BC and cover the entire bottom part BC-B. However, the exemplary embodiment is not limited thereto, and the reflection plate RF may not overlap the light emitting unit LU, as shown in the drawings. For example, the reflection plate RF may be disposed on the bottom part BC-B of the bottom cover BC between the light emitting units LU.

The reflection plate RF may include a reflective film or a reflective coating layer. The reflection plate RF may reflect the light provided on the side of the bottom part BC-B of the bottom cover BC and allow the light to enter the inside of the first base substrate BS1 of the first substrate SUB1 again.

Referring to FIG. 2, in the liquid crystal display device DD of one exemplary embodiment, the liquid crystal display panel DP may include a first substrate SUB1, a liquid crystal layer LCL, and a second substrate SUB2, which are sequentially stacked in the direction of a third directional axis DR3. For example, the first substrate SUB1 may be referred to as a lower substrate, and the second substrate SUB2 may be referred to as an upper part substrate.

In the liquid crystal display panel DP according to an exemplary embodiment, the first substrate SUB1 may include a first base substrate BS1, a color conversion layer CCL disposed on the first base substrate BS1 and including a quantum dot QD (FIG. 4), and a first polarizing layer POL1 disposed on the first base substrate BS1. Referring to FIG. 2, in the liquid crystal display DD according to an exemplary embodiment, the first base substrate BS1, the color conversion layer CCL, and the first polarizing layer POL1 may be sequentially stacked in the direction of the third directional axis DR3.

The first base substrate BS1 may be made of glass. However, the exemplary embodiment is not limited thereto. The first base substrate BS1 may be made of a polymer resin, and for example, may be formed including an acrylic resin or the like. The first base substrate BS1 may be used as a lower substrate of the liquid crystal display panel DP of one exemplary embodiment. The first base substrate BS1 may serve as a substrate on which the color conversion layer CCL, the first polarizing layer POL1, and the like described later are disposed.

The first substrate SUB1 may include the color conversion layer CCL including the quantum dot QD (see FIG. 4). For example, in one exemplary embodiment, the color conversion layer CCL may be disposed on the upper part surface BS1-T of the first base substrate BS1. In addition, in one exemplary embodiment, the color conversion layer CCL may be directly disposed on the upper part surface BS1-T of the first base substrate BS1.

FIG. 4 is a cross-sectional view of a color conversion layer CCL in one exemplary embodiment. The color conversion layer CCL may include a base resin BR and a quantum dot QD. The quantum dot QD may be dispersed in the base resin BR.

The base resin BR is a medium in which a quantum dot QD is dispersed and may be made of various resin compositions which may be generally referred to as a binder. However, the inventive concepts are not limited thereto, and a medium capable of dispersing a quantum dot QD in this specification may be referred to as a base resin BR regardless of its name, additional other functions, constituent materials, and the like. The base resin BR may be a polymer resin. For example, the base resin BR may be an acrylic resin, a urethane resin, a silicone resin, an epoxy resin, or the like. The base resin BR may be a transparent resin.

The quantum dot QD may be a particle that changes the wavelength of the light provided from the light emitting unit LU (see FIG. 2). The quantum dot QD is a material with a crystal structure of a few nanometers in size and consists of hundreds to thousands of atoms, and shows a quantum confinement effect in which an energy band gap is increased due to a small size. When a light of a wavelength with energy higher than a band gap is incident on the quantum dot QD, the quantum dot QD absorbs the light and becomes excited and drops to the ground state while emitting a light of a specific wavelength. The light of the emitted wavelength has a value corresponding to the band gap. The quantum dot QD may adjust the light emission characteristics of the quantum confinement effect when adjusting its size and composition. The quantum dot QD may be selected from Group II-VI compounds, Group III-V compounds, Group IV-VI compounds, Group IV elements, Group IV compounds, and combinations thereof.

The Group II-VI compound may be selected from bivalent element compounds selected from the group consisting of CdSe, CdTe, ZnS, ZnSe, ZnTe, ZnO, HgS, HgSe, HgTe, MgSe, MgS, and compounds thereof; trivalent element compounds selected from the group consisting of CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and compounds thereof; and tetravalent element compounds selected from the group consisting of HgZnTeS, CdZnSeS, CdZnSeTe, CdZnSTe, CdHgSeS, CdHgSeTe, CdHgSTe, HgZnSeS, HgZnSeTe, HgZnSTe, and compounds thereof.

The Group III-V compound may be selected from bivalent element compounds selected from the group consisting of GaN, GaP, GaAs, GaSb, AlN, AlP, AlAs, AlSb, InN, InP, InAs, InSb, and compounds thereof; trivalent element compounds selected from the group consisting of GaNP, GaNAs, GaNSb, GaPAs, GaPSb, AlNP, AlNAs, AlNSb, AlPAs, AlPSb, InNP, InNAs, InNSb, InPAs, InPSb, GaAlNP, and compounds thereof; and tetravalent element compounds selected from the group consisting of GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, and compounds thereof.

The Group IV-VI compound may be selected from bivalent element compounds selected from the group consisting of SnS, SnSe, SnTe, PbS, PbSe, PbTe, and compounds thereof; trivalent element compounds selected from the group consisting of SnSeS, SnSeTe, SnSTe, PbSeS, PbSeTe, PbSTe, SnPbS, SnPbSe, SnPbTe, and compounds thereof; and tetravalent element compounds selected from the group consisting of SnPbSSe, SnPbSeTe, SnPbSTe, and compounds thereof. The Group IV elements may be selected from the group consisting of Si, Ge, and compounds thereof. The IV group compound may be a bivalent element compound selected from the group consisting of SiC, SiGe, and compounds thereof.

At this time, the bivalent element compound, the trivalent element compound, or the tetravalent element compound may be present in the particle at a uniform concentration, or may be present in the same particle by dividing the concentration distribution into a partially different state.

The quantum dot QD may have a core shell structure including a core and a shell surrounding the core. Also, one quantum dot may have a core/shell structure surrounding other quantum dots. The interface between the core and the shell may have a concentration gradient that is lowered as the concentration of the element in the shell approaches the center.

The quantum dot QD may be a particle having a nanometer scale size. The quantum dot QD may have a full width of half maximum (FWHM) of the emission wavelength spectrum of about 45 nm or less, preferably about 40 nm or less, more preferably about 30 nm or less, and in this range, color purity and color reproducibility may be improved. Further, since light emitted through the quantum dot QD is emitted in all directions, a wide viewing angle may be improved.

The shape of the quantum dot QD is not particularly limited as long as it is a form commonly used in the art, and more specifically, it may be in the form of spherical, pyramidal, multi-arm or cubic nanoparticles, nanotubes, nanowires, nanofibers, nano platelike particles, and the like.

In one exemplary embodiment, the color conversion layer CCL may include a plurality of quantum dots QD that convert incident light into colors in different wavelength ranges. Referring to FIG. 4, in one exemplary embodiment, the color conversion layer CCL includes, for example, a first quantum dot QD1 for converting incident light of a specific wavelength into a first wavelength and emitting it and a second quantum dot QD2 for converting the incident light of the specific wavelength into a second wavelength and emitting it. In one exemplary embodiment, the color conversion layer CCL may further include scattering particles, in addition to a base resin BR and at least one of the first quantum dot QD1 and the second quantum dot QD2, dispersed in the base resin BR. The scattering particles may be TiO₂ or silica-based nanoparticles. The scattering particles may scatter the light emitted from the first quantum dot QD1 and the second quantum dot QD2 to be emitted to the outside the color conversion layer CCL.

For example, in a case where the color conversion layer CCL includes a plurality of first quantum dot QD1 and the second quantum dot QD2, when the light provided from the light emitting unit LU (FIG. 2) is light in the blue light wavelength range, the first quantum dot QD1 may convert blue light into light of a green light wavelength and the second quantum dot QD2 may convert blue light into light of a red light wavelength. Specifically, when the light provided from the light emitting unit LU (FIG. 2) is blue light having the maximum emission peak (or central wavelength) at 420 nm to 470 nm, the first quantum dot QD1 emits green light having a maximum emission peak (or central wavelength) at 520 nm to 570 nm, and the second quantum dot QD2 may emit red light having a maximum emission peak (or central wavelength) at 620 nm to 670 nm. However, the blue light, the green light, and the red light are not limited to the examples of the wavelength ranges shown above, and it should be understood that the inventive concepts include all wavelength ranges that may be recognized as blue light, green light, and red light.

Meanwhile, in relation to the first quantum dot QD1 and the second quantum dot QD2, depending on the particle size, the color of the emitted light may change, and the particle sizes of the first quantum dot QD1 and the second quantum dot QD2 may be different from each other. For example, the particle size of the first quantum dot QD1 may be smaller than the particle size of the second quantum dot QD2. At this time, the first quantum dot QD1 may emit light having a shorter wavelength than the second quantum dot QD2.

In FIG. 2, a color conversion layer CCL may be formed by coating on a first base substrate BS1. The color conversion layer CCL may be provided on the first base substrate BS1 using various methods such as slit coating, spin coating, roll coating, spray coating, and inkjet printing.

Referring to FIG. 2, in one exemplary embodiment, the first substrate SUB1 of the liquid crystal display panel DP may include a first polarizing layer POL1. The first polarizing layer POL1 may be an in-cell polarizing layer disposed between the first base substrate BS1 and the liquid crystal layer LCL.

The first polarizing layer POL1 may be a coated polarizing layer or a polarizing layer formed by deposition. The first polarizing layer POL1 may be formed by coating a substance including a dichroic dye and a liquid crystal compound. Alternatively, the first polarizing layer POL1 may be a wire grid type polarizing layer.

In addition, the first substrate SUB1 may include a common electrode CE disposed on the first polarizing layer POL1 and disposed adjacent to the liquid crystal layer LCL. Meanwhile, although not shown in the drawing, the first substrate SUB1 may further include an alignment layer for aligning liquid crystal molecules of the liquid crystal layer LCL.

The common electrode CE forms an electric field together with the pixel electrode PE included in the second substrate SUB2 to control the liquid crystal layer LCL. The common electrode CE may be formed of a transparent conductive material. The common electrode CE may be formed of a conductive metal oxide such as indium tin oxide (ITO), indium zinc oxide (IZO), indium tin zinc oxide (ITZO), or the like. An alignment layer may be disposed on the common electrode CE.

A barrier layer PL may be disposed on the color conversion layer CCL. Meanwhile, unlike what is shown in the drawing, the barrier layer PL may be disposed on at least one of the upper part surface and the lower part surface of the color conversion layer CCL. That is, the liquid crystal display device DD of the exemplary embodiment may further include a barrier layer disposed between the first base substrate BS1 and the color conversion layer CCL. When the first substrate SUB1 further includes a barrier layer disposed on the lower part surface of the color conversion layer CCL, a barrier layer disposed on the lower part surface of the color conversion layer CCL may be disposed directly on the first base substrate BS1.

The barrier layer PL serves to prevent or suppress penetration of moisture and/or oxygen. The barrier layer PL may include at least one inorganic layer. That is, the barrier layer PL may include an inorganic material. For example, the barrier layer PL may include silicon nitride, aluminum nitride, zirconium nitride, titanium nitride, hafnium nitride, tantalum nitride, silicon oxide, aluminum oxide, titanium oxide, tin oxide, cerium oxide, and silicon oxynitride or a metal thin film or the like having secured light transmittance. The barrier layer PL may further include an organic film. The barrier layer PL may be composed of a single layer or a plurality of layers.

In one exemplary embodiment, the first substrate SUB1 of the liquid crystal display panel DP may include only one support substrate. For example, the first substrate SUB1 of the liquid crystal display panel DP may include a single glass substrate or a single polymer substrate, and the first base substrate BS1 may be the single glass substrate or the single polymer substrate. That is, the first substrate SUB1 includes only one substrate serving as a base, thereby reducing the overall thickness of the liquid crystal display device DD of one exemplary embodiment. That is, by providing the color conversion layer CCL on the first base substrate BS1 and omitting a separate support substrate for the color conversion layer CCL, the thickness of the entire liquid crystal display device DD may be reduced. In addition, as the color conversion layer CCL is provided in the in-cell form, as compared with a case where the liquid crystal display panel DP is provided as a separate member to the outside of the liquid crystal display panel DP, it is possible to reduce the damage of the color conversion layer CCL in the manufacturing process.

The liquid crystal display panel DP of the exemplary embodiment shown in FIG. 2 includes a second substrate SUB2 facing the first substrate SUB1, and the second substrate SUB2 may include a second base substrate BS2, a second polarizing layer POL2, and a circuit layer CL.

The second base substrate BS2 may be made of glass. However, the exemplary embodiment is not limited thereto. The second base substrate BS2 may be made of a polymer resin, and for example, may be formed including an acrylic resin or the like. The second base substrate BS2 may be used as an upper substrate of the liquid crystal display panel DP of one exemplary embodiment. The second base substrate BS2 may serve as a base on which the circuit layer CL, the color filter layer CFL, and the like to be described later are disposed.

The circuit layer CL may be disposed on the lower part surface BS2-B of the second base substrate BS2. For example, the circuit layer CL may include a thin film transistor TFT (see FIG. 6) described later. The thin film transistor TFT (see FIG. 6) may be connected to the pixel electrode PE.

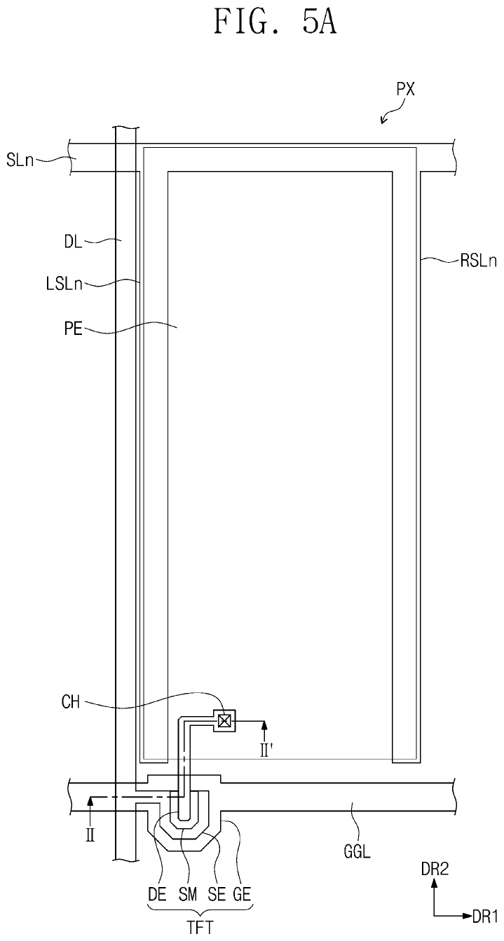

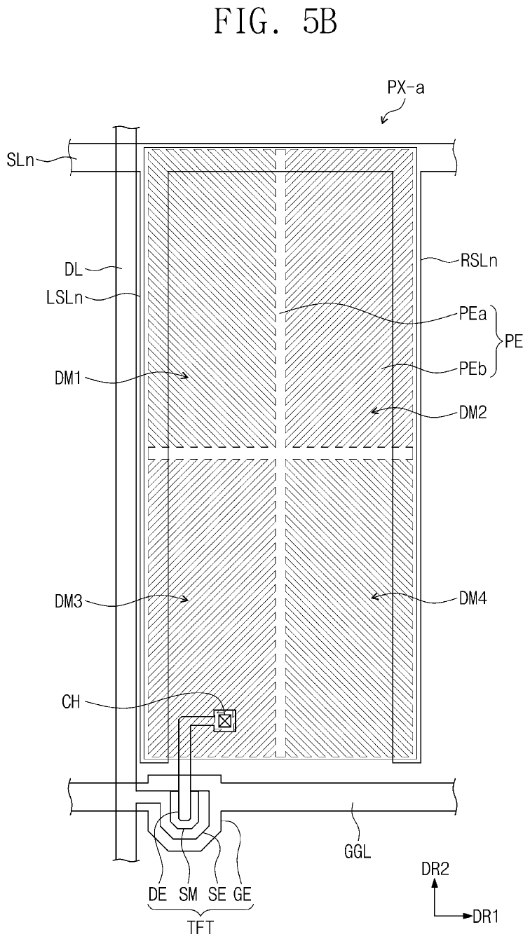

FIGS. 5A and 5B are plan views schematically showing one pixel among the pixels included in the liquid crystal display panel DP according to an exemplary embodiment. FIG. 6 is a cross-sectional view taken along a sectional line II-IF of FIG. 5A.

FIGS. 5A and 5B show one pixel PX or PX-a as an example, and the structure of each of the remaining pixels may be similar to the structure of the pixels PX and PX-a shown in FIGS. 5A and 5B. In FIGS. 5A and 5B, for convenience of explanation, one pixel PX or PX-a connected to one gate line among the gate lines GGL and one data line among the data lines DL is shown, but the exemplary embodiment is not limited thereto. For example, one gate line and one data line may be connected to a plurality of pixels, and a plurality of gate lines and a plurality of data lines may be connected to one pixel. Referring to FIGS. 5A, 5B, and 6, the gate line GGL is formed extending in the first directional axis DR1. The gate line GGL may be formed on the second base substrate BS2. For example, the gate line GGL may be formed on the lower part surface of the second base substrate BS2. The data line DL may be provided extending in the direction of the second directional axis DR2 intersecting the gate line GGL.

Each of the pixels PX and PX-a includes a thin film transistor TFT, a pixel electrode PE connected to the thin film transistor TFT, and a storage electrode part. The thin film transistor TFT includes a gate electrode GE, a semiconductor pattern SM, a first electrode SE or a source electrode, and a second electrode DE or a drain electrode. The storage electrode part includes a storage line SLn extended in the direction of the first directional axis DR1, and a first branch electrode LSLn and a second branch electrode RSLn branched from the storage line SLn and extending in the direction of the second directional axis DR2.

The gate electrode GE protrudes from the gate line GGL or is provided on a partial area of the gate line GGL. In one exemplary embodiment, the gate electrode GE may be disposed on the lower part surface BS2-B of the second base substrate BS2.

The gate electrode GE may be made of metal. The gate electrode GE may be made of nickel, chromium, molybdenum, aluminum, titanium, copper, tungsten, and alloys thereof. The gate electrode GE may be formed of a single film or multiple films using a metal. For example, the gate electrode GE may be a triple film in which molybdenum, aluminum, and molybdenum are sequentially stacked, or a double film in which titanium and copper are sequentially stacked. Alternatively, it may be a single film of an alloy of titanium and copper.

The semiconductor pattern SM is provided on the gate insulating film GI. The semiconductor pattern SM is provided on the gate electrode GE with the gate insulating film GI therebetween. In the semiconductor pattern SM, a partial area overlaps the gate electrode GE. The semiconductor pattern SM includes an active pattern provided on the gate insulating film GI and an ohmic contact layer formed on the active pattern. The active pattern may be formed of an amorphous silicon thin film, and the ohmic contact layer may be formed of an n+ amorphous silicon thin film. The ohmic contact layer makes ohmic contact between the active pattern and the first electrode SE and the second electrode DE.

The first electrode SE is provided branched from the data lines DL. The first electrode SE is formed on the ohmic contact layer, and a partial area overlaps the gate electrode GE. The data line DL may be disposed in an area where the semiconductor pattern SM is not disposed in the gate insulating film GI.

The second electrode DE is provided apart from the first electrode SE with the semiconductor pattern SM therebetween. The second electrode DE is formed on the ohmic contact layer, and a partial area is provided to overlap the gate electrode GE.

The first electrode SE and the second electrode DE may be made of nickel, chromium, molybdenum, aluminum, titanium, copper, tungsten, and alloys thereof. The first electrode SE and the second electrode DE may be formed of a single film or a multi-layer film using a metal. For example, the first electrode SE and the second electrode DE may be a double film in which titanium and copper are sequentially stacked. Alternatively, it may be a single film of an alloy of titanium and copper.

Thus, the upper surface of the active pattern between the first electrode SE and the second electrode DE is exposed, and a channel part constituting a conductive channel is formed between the first electrode SE and the second electrode DE depending on whether a voltage is applied to the gate electrode GE. The first electrode SE and the second electrode DE overlap a part of the semiconductor pattern SM in an area except for a channel part formed apart between the first electrode SE and the second electrode DE.

The insulating layer PS covers the first electrode SE, the second electrode DE, the channel portion, and the gate insulating film GI, and may be disposed to expose a part of the second electrode DE. The second electrode DE exposed in the insulating layer PS may be connected to the pixel electrode PE. The insulating layer PS may include, for example, silicon nitride or silicon oxide.

The pixel electrode PE partially overlaps the storage line SLn, the first branch electrode LSLn, and the second branch electrode RSLn to form a storage capacitor.

Referring to FIG. 5B, another example of pixel PX-a illustrated in FIG. 5B is different from the pixel PX illustrated in FIG. 5A in that the pixel electrode PE is divided into a plurality of domains DM1, DM2, DM3, and DM4. In FIG. 5B, the pixel electrode PE includes a stem part PEa and a plurality of branch parts PEb protruding radially and extending from the stem part PEa. Parts of the stem part PEa or the branch parts PEb are connected to the second electrode DE through the contact hole CH.

The stem part PEa may be provided in various shapes, and may be provided in a cross shape, for example, as in one exemplary embodiment of the inventive concepts. The branch parts PEb are spaced apart from each other to be not in contact and extend in parallel directions within the area defined by the stem part PEa. The branch parts PEb adjacent to each other are spaced apart by a distance in the units of micrometers, and this corresponds to a means for aligning the liquid crystal molecules of the liquid crystal layer LCL at a specific azimuth angle.

Each of the pixels PX-a may be divided into a plurality of domains DM1, DM2, DM3, and DM4 by the stem part PEa. The branch parts PEb correspond to the respective domains DM1, DM2, DM3, and DM4 and may extend in different directions for the respective domains DM1, DM2, DM3, and DM4. In one exemplary embodiment of the inventive concepts, although it is shown as an example that each of the pixels PX includes four domains, the inventive concepts are not limited thereto, and each of the pixels PX-a may include various numbers of domains such as 2, 6, 8, and so on. In addition, the division forms of the domains are not limited to those shown in FIG. 5B.

The circuit layer CL may include a thin film transistor TFT including a gate electrode GE, a semiconductor pattern SM, a first electrode SE, and a second electrode DE. The circuit layer CL may include a thin film transistor TFT, a gate insulating film GI, and an insulating layer PS.

In one exemplary embodiment, the second substrate SUB2 may further include a low reflection pattern ML. For example, the low reflection pattern ML may be disposed on the second base substrate BS2. The low reflection pattern ML may be disposed on the upper part surface or the lower part surface of the second base substrate BS2. The low reflection pattern ML may be a pattern made of a metal having a low reflectance and may function to block a part of light transmitted through the second base substrate BS2 and provided to the circuit layer CL. For example, the low reflection pattern ML may be disposed overlapping a part of the configuration of the circuit layer CL. Specifically, the low reflection pattern ML may be disposed overlapping a part of the configuration of the thin film transistor TFT. By arranging the low reflection pattern ML, it is possible to partially block the external light from being reflected by the thin film transistor TFT. Referring to FIG. 6, a color filter layer CFL may be disposed on the lower side of the insulating layer PS. That is, the color filter layer CFL may be disposed between the circuit layer CL and the liquid crystal layer LCL. Meanwhile, although it is shown in FIG. 6 that the color filter layer CFL covers the entire thin film transistor TFT, the exemplary embodiment is not limited thereto, and the color filter layer CFL may overlap only a part of the thin film transistor TFT.

The pixel electrode PE may be disposed to face the common electrode CE with the liquid crystal layer LCL therebetween. The pixel electrode PE may be disposed between the liquid crystal layer LCL and the color filter layer CFL. The pixel electrode PE is formed of a transparent conductive material. In particular, the pixel electrode PE is formed of a transparent conductive oxide. The transparent conductive oxide may be indium tin oxide (ITO), indium zinc oxide (IZO), indium tin zinc oxide (ITZO), or the like.

Referring again to FIG. 2, the second substrate SUB2 may include a color filter layer CFL disposed between the liquid crystal layer LCL and the circuit layer CL. The color filter layer CFL may include a plurality of filter parts CF1 and CF2 that transmit light having wavelength ranges different from each other. A light blocking part BM may be further disposed between adjacent filter parts among the plurality of filter parts CF1 and CF2. The light blocking part BM may be disposed overlapping the boundary BRL of adjacent filter parts CF1 and CF2.

The light blocking part BM may be a black matrix. The black blocking part BM may be formed by including an organic light-shielding material or an inorganic light-shielding material including a black pigment or a dye. The light blocking part BM may prevent or suppress light leakage and distinguishes adjacent filter parts CF1 and CF2.

Meanwhile, although it is shown in FIG. 2 that two adjacent filter parts CF1 and CF2 are shown, the inventive concepts are not limited thereto, and the color filter layer CFL may include three or more filter parts that transmit light of different wavelength ranges. For example, the color filter layer CFL may include a red filter part, a green filter part, and a blue filter part, or the color filter layer CFL may include a red filter part, a green filter part, a blue filter part, a white filter part, and the like, but the exemplary embodiment is not limited thereto. The arrangement order of the filter parts that transmit light of different wavelength ranges included in the color filter layer CFL may be variously combined.

In addition, although it is shown in FIG. 2 that two adjacent filter parts CF1 and CF2 are partially overlapped in the direction of the third directional axis DR3, which is a thickness direction, the exemplary embodiment is not limited thereto. For example, two adjacent filter parts CF1 and CF2 may be spaced apart from each other on a plane. In this case, the light blocking part BM may be disposed between the separated filter parts CF1 and CF2 or may be at least partially overlapped with the edge parts of each of the separated filter parts CF1 and CF2.

Meanwhile, it is shown in FIG. 2 that the liquid crystal display device DD of the exemplary embodiment has a color filter on array (COA) structure in which a circuit layer CL and a color filter layer CFL are formed on a single substrate. However, the exemplary embodiment is not limited thereto. In the liquid crystal display device DD of one exemplary embodiment, the circuit layer CL may be included in the second substrate SUB2 and the color filter layer CFL may be included in the first substrate. The second substrate SUB2 includes a second polarizing layer POL2. In an exemplary embodiment shown in FIG. 2, the second polarizing layer POL2 included in the second substrate SUB2 may be a coating type polarizing layer or a polarizing layer formed by deposition. Alternatively, unlike this, the second polarizing layer POL2 may be a film-type polarizing member separately manufactured and provided on the second base substrate BS2.

Meanwhile, although it is shown in FIG. 2 that the second polarizing layer POL2 is disposed on the upper part surface BS2-T of the second base substrate BS2, the exemplary embodiment is not limited thereto. In other words, in the liquid crystal display device DD of one exemplary embodiment, the second polarizing layer POL2 may be disposed on the lower side of the second base substrate BS2 and provided in an in-cell type. The second polarizing layer POL2 may be disposed between the liquid crystal layer LCL and the color filter layer CFL or between the color filter layer CFL and the second base substrate BS2.

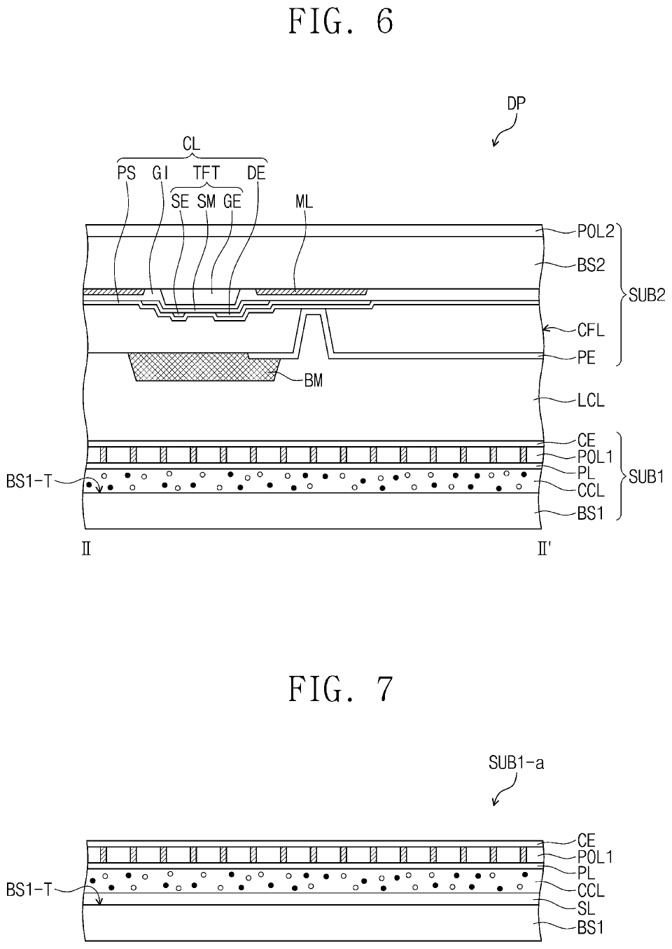

Hereinafter, FIGS. 7, 8, 9, 11, and 12 illustrate embodiments with a different configuration from the first substrate SUB1 in the liquid crystal display device DD of the exemplary embodiment shown in FIG. 2. FIGS. 7, 8, 9, 11, and 12 are cross-sectional views showing a configuration of a first substrate according to each exemplary embodiment. According to the first base substrate BS1, the barrier layer PL, the first polarizing layer POL1, and the common electrode CE in FIGS. 7, 8, 9, 11, and 12, the same contents as those described with reference to FIG. 4 may be applied.

Referring to FIG. 7, the first substrate SUB1-a may further include a scattering layer SL. The scattering layer SL may be disposed between the first base substrate BS1 and the color conversion layer CCL. The scattering layer SL may be disposed directly on the upper part surface BS1-T of the first base substrate BS1.

The scattering layer SL may scatter the light emitted from the light emitting unit LU (see FIG. 2) and pass through the first base substrate BS1 to prevent or suppress the hot spot phenomenon. The scattering layer SL may include a base resin and scattering particles mixed (or dispersed) in the base resin. The scattering particles may include inorganic particles. The scattering layer SL may include scattering particles of at least one of TiO₂, SiO₂, ZnO, Al₂O₃, BaSO₄, CaCO₃, or ZrO₂.

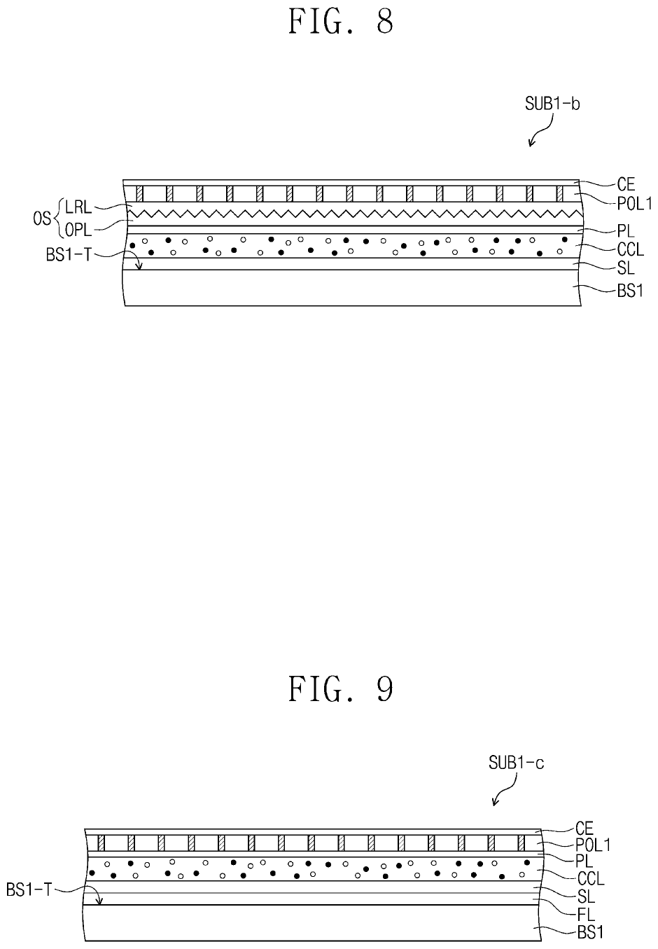

The first substrate SUB1-b according to an exemplary embodiment shown in FIG. 8 may further include a scattering layer SL and a light condensing layer OS as compared with the first substrate SUB1 shown in FIG. 2. The first substrate SUB1-b may include a scattering layer SL disposed between the first base substrate BS1 and the color conversion layer CCL, and a light condensing layer OS disposed between the color conversion layer CCL and the first polarizing layer POL1. For the scattering layer SL, the same contents described with reference to FIG. 7 may be applied.

The light condensing layer OS may condense the light, which is emitted from the light emitting unit LU (see FIG. 2) and penetrates the first base substrate BS1, toward the direction of the liquid crystal layer LCL. The light condensing layer OS may include a condensing pattern part OPL and a low refractive part LRL provided on the condensing pattern part OPL. The condensing pattern part OPL may include a protruding pattern protruding toward the liquid crystal layer LCL. The protruding pattern may be a prism pattern or the like, but the exemplary embodiment is not limited thereto, and the protruding pattern may be provided in various shapes.

The low reflective part LRL is disposed on the condensing pattern part OPL and may fill between the protruding patterns of the condensing pattern part OPL and may be disposed. The refractive index of the low reflective part LRL may be less than the refractive index of the condensing pattern part OPL. The refractive index of the low reflective part LRL may be 1.2 or more and 1.4 or less. A low reflective part LRL may be disposed on the condensing pattern part OPL to increase the condensing efficiency of the condensing pattern part OPL.

The first substrate SUB1-c according to an exemplary embodiment shown in FIG. 9 may further include a scattering layer SL and a filter layer FL as compared with the first substrate SUB1 shown in FIG. 2. The first substrate SUB1-c may include a scattering layer SL and a filter layer FL disposed between the first base substrate BS1 and the color conversion layer CCL. For the scattering layer SL, the same contents described with reference to FIG. 7 may be applied.

In the exemplary embodiment shown in FIG. 9, the filter layer FL may be disposed on the upper side of the first base substrate BS1. However, the exemplary embodiment is not limited thereto. The filter layer FL may transmit the first light and reflect the second light and the third light in a wavelength range different from that of the first light. That is, the filter layer FL may be a selective transmissive reflective layer. For example, the filter layer FL may transmit blue light and reflect red light and green light. That is, the filter layer FL may increase the efficiency of light provided from the light emitting unit LU (see FIG. 2) to the liquid crystal layer LCL.

In the exemplary embodiment shown in FIG. 9, although it is shown that the scattering layer SL is disposed on the upper side of the filter layer FL, the exemplary embodiment is not limited thereto. Unlike what is shown, the filter layer FL may be disposed on the upper side of the scattering layer SL.

The filter layer FL may be a single layer or a stack of a plurality of insulating films. For example, the filter layer FL is formed including a plurality of insulating films, and the transmission and reflection wavelength ranges may be determined depending on the refractive index difference between the stacked layers, the thickness of each of the stacked layers, and the number of stacked layers.

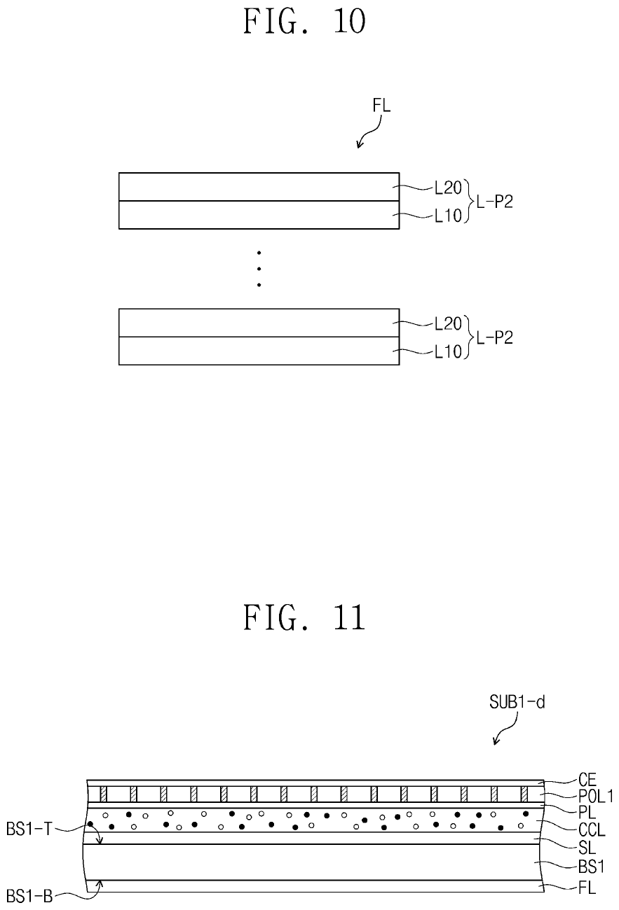

Referring to FIG. 10, in one exemplary embodiment, the filter layer FL may include a first insulating layer L10 and a second insulating layer L20 having different refractive indices. The filter layer FL may include at least one first insulating film L10 and at least one second insulating film L20. The refractive index of the first insulating film L10 may be 1.4 to 1.6 and the refractive index of the second insulating film L20 may be 1.9 to 2.1.

For example, a metal oxide material may be used for the second insulating layer L20 having a relatively high refractive index. Specifically, the second insulating layer L20 having a high refractive index may include at least one of TiOx, TaOx, HfOx, and ZrOx. In addition, the first insulating layer L10 having a relatively low refractive index may include SiOx, SiCOx, or the like. Also, in one exemplary embodiment, the filter layer FL may be formed by alternately repeating deposition of SiNx and SiOx.

The continuously stacked first insulating film L10 and the second insulating film L20 may be defined as a unit layer L-P2. The filter layer FL may include a plurality of unit layers L-P2. For example, the filter layer FL may include unit layers L-P2 of 1 or more and 15 or less but the exemplary embodiment is not limited thereto.

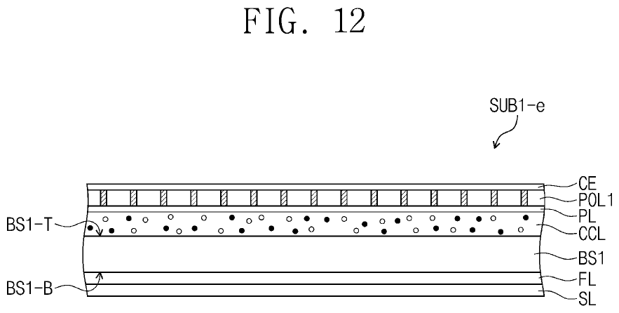

The first substrates SUB1-d and SUB1-e in a liquid crystal display device according to the exemplary embodiments shown in FIGS. 11 and 12 may further include a scattering layer SL and a filter layer FL as compared with the first substrate SUB1 shown in FIG. 2. According to the first substrates SUB1-d and SUB1-e of exemplary embodiments shown in FIGS. 11 and 12, at least one of the scattering layer SL and the filter layer FL may be disposed on the lower part surface BS1-B of the first base substrate BS1.

Referring to FIG. 11, the first substrate SUB1-d includes a first base substrate BS1, a scattering layer SL disposed on the upper side of the first base substrate BS1, a color conversion layer CCL, a barrier layer PL, a first polarizing layer POL1, a common electrode CE, and a filter layer FL disposed on the lower side of the first base substrate BS1. According to the first base substrate BS1, the barrier layer PL, the first polarizing layer POL1, and the common electrode CE, the same contents as those described with reference to FIGS. 2 and 4 may be applied. For the scattering layer SL, the same contents as those described with reference to FIG. 7 may be applied, and for the filter layer FL, the same contents as those described with reference to FIGS. 9 and 10 may be applied. Compared to the configuration of the first substrate SUB1-d shown in FIG. 11, the filter layer FL may be disposed on the upper side of the first base substrate BS1 and the scattering layer SL may be disposed on the lower side of the first base substrate BS1. That is, one of the scattering layer SL and the filter layer FL may be provided in an in-cell type and the other may be spaced apart from the liquid crystal layer LCL and provided to the outside of the cell.

FIG. 12 shows a first substrate SUB1-e in which both the scattering layer SL and the filter layer FL are disposed on the lower side of the first base substrate BS1. Although it is shown in FIG. 12 that the filter layer FL is disposed closer to the lower part surface BS1-B of the first base substrate BS1, the exemplary embodiment is not limited thereto. Unlike what is shown, the scattering layer SL may be disposed more adjacent to the first base substrate BS1 than the filter layer FL. Referring to FIG. 8, the light condensing layer OS described in the exemplary embodiment of FIG. 8 may be selectively included in the first substrates SUB1-a, SUB1-c, SUB1-d, and SUB1-e described with reference to FIGS. 7, 9, 11, and 12. When the first substrates SUB1-a, SUB1-c, SUB1-d, and SUB1-e include both the light condensing layer OS and the scattering layer SL, the light condensing layer OS may be disposed on the upper side of the scattering layer SL.

The liquid crystal display device DD of the exemplary embodiment described with reference to FIGS. 1, 2, 3A, 3B, 4, 5A, 5B, 6, 7, 8, 9, 10, and 11 may include a liquid crystal display panel DP and a light source member LM disposed on the lower side of the liquid crystal display panel DP. The liquid crystal display panel DP includes a first substrate SUB1 and a second substrate SUB2 facing each other and a liquid crystal layer LCL disposed between the first substrate SUB1 and the second substrate SUB2. The light source member LM may be one which provides the first color light to the liquid crystal display panel DP.

In one exemplary embodiment, the first substrate SUB1 may include a first base substrate BS1, a color conversion layer CCL disposed on the upper side of the first base substrate BS1 and including a quantum dot, a first polarizing layer POL1 disposed on the upper side of the color conversion layer CCL, and a scattering layer SL disposed on the upper side or lower side of the first base substrate BS1. Also, the second substrate SUB2 may include a second base substrate BS2, a circuit layer CL disposed on the lower side of the second base substrate BS2, a color filter layer CFL disposed between the liquid crystal layer LCL and the circuit layer CL, and a second polarizing layer POL2 disposed on the upper side of the second base substrate BS2.

Meanwhile, the first color light provided from the light source member LM may have a center wavelength of 420 nm to 470 nm. In addition, the color conversion layer CCL may include a first quantum dot QD1 that is excited by the first color light to emit a second color light having a center wavelength of 520 nm to 570 nm and a second quantum dot QD2 that is excited by the first color light to emit a third color light having a center wavelength of 620 nm to 670 nm.

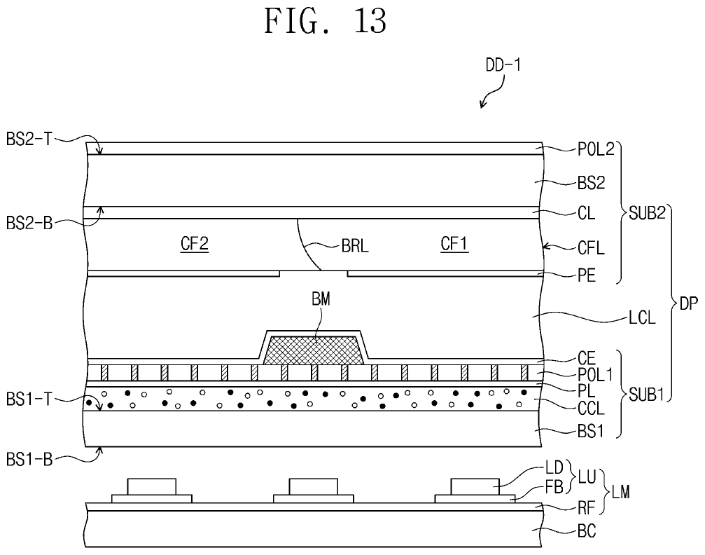

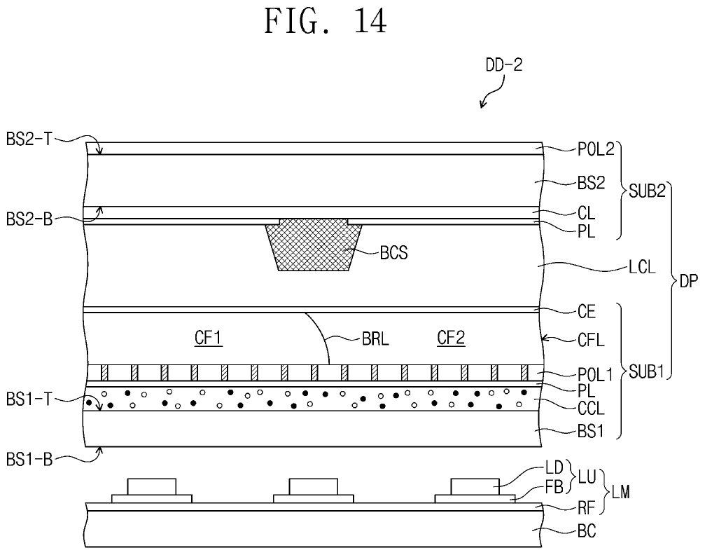

FIGS. 13 and 14 are cross-sectional views showing a liquid crystal display device of an exemplary embodiment. Referring to FIGS. 13 and 14, the liquid crystal display devices DD-1 and DD-2 of one exemplary embodiment may include a light source member LM and a liquid crystal display panel DP provided on the light source member LM. In one exemplary embodiment, the liquid crystal display panel DP includes a first substrate SUB1 and a second substrate SUB2 facing each other and a liquid crystal layer LCL disposed between the first substrate SUB1 and the second substrate SUB2. The first substrate SUB1 may be adjacent to the light source member LM. In FIGS. 13 and 14, for the light source member LM, the first substrate SUB1, and the second substrate SUB2, the contents described with reference to FIGS. 1, 2, 3A, 3B, 4, 5A, 5B, 6, 7, 8, 9, 10, and 11 may be identically applied.

The liquid crystal display DD-1 of the exemplary embodiment shown in FIG. 13 differs in that the light blocking part BM is included in the first substrate SUB1 as compared with the liquid crystal display device DD of the exemplary embodiment shown in FIG. 2. In the liquid crystal display device DD-1 of the exemplary embodiment shown in FIG. 13, the first substrate SUB1 includes a light blocking part BM, and the light blocking part BM may be disposed on the first polarizing layer POL1. The light blocking part BM may be disposed overlapping the boundary BRL of the plurality of filter parts CF1 and CF2 included in the second substrate SUB2. The liquid crystal display device DD-1 of the exemplary embodiment shown in FIG. 13 has a color filter on array (COA) structure, but there is a difference in that the light blocking part BM is separated from the color filter layer CFL and provided on the lower substrate as compared with the liquid crystal display device DD described above with reference to FIG. 2.

The liquid crystal display DD-2 of the exemplary embodiment shown in FIG. 14 is different from the liquid crystal displays DD and DD-1 of the exemplary embodiment shown in FIG. 2 and FIG. 13 in that the color filter layer CFL is included in the first substrate SUB1. That is, in the liquid crystal display device DD-2 of the exemplary embodiment, the first substrate SUB1 includes a first base substrate BS1, a color conversion layer CCL disposed on the upper side of the first base substrate BS1, a first polarizing layer POL1, and a color filter layer CFL. The color filter layer CFL may be disposed on the first polarizing layer POL1. The common electrode CE may be disposed on the color filter layer CFL.

That is, the liquid crystal display device DD of one exemplary embodiment includes a color filter layer CFL on the first substrate SUB1 adjacent to the light source member LM, and a circuit layer CL on a second substrate SUB2 facing the first substrate SUB1. Referring to FIG. 14, in one exemplary embodiment, the color filter layer CFL and the circuit layer CL may be provided on different substrates. That is, the color filter layer CFL may be included in the first substrate SUB1 that is the lower substrate, and the circuit layer CL may be included in the second substrate SUB2 that is the upper substrate.

Referring to FIG. 14, the liquid crystal display panel DP according to an exemplary embodiment may further include a column spacer BCS. The column spacer BCS may be disposed on the lower side of the second base substrate BS2. Meanwhile, although not shown in the drawings, the column spacer BCS may be disposed on the lower side of the second base substrate BS2 in overlapping with the thin film transistor TFT (see FIG. 6). The column spacer BCS may overlap the thin film transistor TFT (see FIG. 6) and protrude toward the liquid crystal layer LCL from the second substrate SUB2 and may be provided. The column spacer BCS may be one that serves as a support for marinating the cell gap of the liquid crystal layer LCL. Although it is shown in FIG. 14 that the thickness of the column spacer BCS is smaller than the cell gap of the liquid crystal layer LCL, the exemplary embodiment is not limited thereto. The thickness of the column spacer BCS may be the same as the cell gap of the liquid crystal layer LCL. In one exemplary embodiment, the column spacer BCS may be provided integrally with the light blocking part BM (see FIG. 2). Also, part of the column spacers BCS may be provided instead of the light blocking part BM.

The column spacer BCS may include a polymer resin and a pigment or dye injected into the polymer resin. For example, a column spacer BCS may be formed including a black pigment or a dye. At this time, the column spacer BCS may function to protect the thin film transistor TFT (see FIG. 6) by blocking the light provided to the thin film transistor TFT (see FIG. 6).

Also, in order to prevent or suppress the light supplied through the color conversion layer CCL from being provided directly to the circuit layer CL, the column spacer BCS may be provided between the liquid crystal layer LCL and the circuit layer CL. Such a column spacer BCS having a light blocking function may be a black column spacer.

The liquid crystal display device of one exemplary embodiment integrally provides a base substrate, a color conversion layer, and a polarizing layer, and uses the integrally provided substrate as a lower substrate of the liquid crystal display panel, so that compared to a case where a color conversion layer or the like is provided as a separate optical member, a thinner thickness may be realized while displaying the same or higher display quality. Also, since the light provided from the light source member to the liquid crystal layer is provided through the color conversion layer including the quantum dot, the color reproducibility and the luminance of the liquid crystal display device may be improved.

Meanwhile, in the liquid crystal display device of one exemplary embodiment, by providing a color conversion layer and a polarizing layer in an in-cell type, when the color conversion layer is made of a separate optical member, a separate module process for combining the necessary liquid crystal display panel and optical member may be omitted, so that the manufacturing productivity of the liquid crystal display device may be increased. Also, by providing a substrate of a liquid crystal display panel and an optical layer such as a color conversion layer integrally, compared to the case of being provided as a separate optical member, it may reduce the damage of color conversion layer during assembly process so that improved reliability may be provided.

In one exemplary embodiment, as a color conversion layer or the like is provided integrally with a substrate of a liquid crystal display panel, it is possible to provide a liquid crystal display device with a relatively thin thickness while maintaining excellent display quality.

One exemplary embodiment provides an optical functional layer such as a color conversion layer integrally with a substrate of a liquid crystal display panel to minimize the exposure of the color conversion layer to the external environment, so that a liquid crystal display device having excellent optical characteristics and improved reliability may be provided.

In addition, one exemplary embodiment provides an optical functional layer such as a color conversion layer integrally with a substrate of a liquid crystal display panel, so that it is possible to provide a liquid crystal display device with improved manufacturing productivity.

Although the exemplary embodiments of the inventive concepts have been described, it is understood that the inventive concepts should not be limited to these exemplary embodiments but various changes and modifications may be made by one ordinary skilled in the art within the spirit and scope of the inventive concepts as hereinafter claimed.

What is claimed is:

1. A liquid crystal display device comprising:
a light source member comprising a plurality of light emitting element packages; and
a liquid crystal display panel disposed on an upper side of the light source member, the liquid crystal display panel comprising:
a first substrate adjacent to the light source member, the first substrate comprising: a first base substrate; a color conversion layer disposed on an upper side of the first base substrate and comprising a quantum dot; and a first polarizing layer disposed on an upper side of the first base substrate;
a second substrate facing the first substrate, the second substrate comprising: a second base substrate; a second polarizing layer disposed on an upper side of a liquid crystal layer; and a circuit layer disposed on a lower side of the second base substrate; and
the liquid crystal layer disposed between the first substrate and the second substrate.

2. The liquid crystal display device of claim 1, wherein the second substrate further comprises a color filter layer disposed between the liquid crystal layer and the circuit layer, the color filter layer comprising a plurality of filter parts for transmitting light of different wavelength ranges.

3. The liquid crystal display device of claim 2, wherein the second substrate further comprises a light blocking part disposed overlapping a boundary of adjacent filter parts among the filter parts.

4. The liquid crystal display device of claim 2, wherein the first substrate further comprises a light blocking part overlapping a boundary of adjacent filter parts among the filter parts and disposed on the first polarizing layer.

5. The liquid crystal display device of claim 1, wherein the first substrate further comprises a color filter layer disposed between the color conversion layer and the liquid crystal layer.

6. The liquid crystal display device of claim 1, further comprising a barrier layer disposed on at least one of an upper surface and a lower surface of the color conversion layer.

7. The liquid crystal display device of claim 1, wherein the first substrate is disposed on one of an upper side and a lower side of the first base substrate, and
wherein the first substrate further comprises a scattering layer comprising a scattering particle of at least one of TiO₂, SiO₂, ZnO, Al₂O₃, BaSO₄, CaCO₃, and ZrO₂.

8. The liquid crystal display device of claim 1, wherein the first substrate further comprises a light condensing layer disposed on an upper side of the color conversion layer.

9. The liquid crystal display device of claim 8, wherein the light condensing layer comprises:
a condensing pattern part comprising a protruding pattern protruding toward a direction of the liquid crystal layer; and
a low reflective part disposed on the condensing pattern part to cover the protruding pattern.

10. The liquid crystal display device of claim 1, wherein the first substrate is disposed on one of an upper side and a lower side of the first base substrate, and
wherein the first substrate further comprises a filter layer configured to transmit blue light and reflect red light and green light.

11. The liquid crystal display device of claim 10, wherein the filter layer comprises:
a plurality of first insulating films and a plurality of second insulating films,
wherein the plurality of first insulating films and the plurality of second insulating films are alternately arranged with each other, and
wherein the plurality of first insulating films and the plurality of second insulating films have different refractive index from each other.

12. The liquid crystal display device of claim 11, wherein a refractive index of the first insulating films is equal to or greater than 1.4 and equal to or less than 1.6, and
wherein a refractive index of the second insulating films is equal to or greater than 1.9 and equal to or less than 2.1.

13. The liquid crystal display device of claim 1, wherein the color conversion layer is disposed directly on an upper surface of the first base substrate.

14. The liquid crystal display device of claim 1, wherein the first polarizing layer comprises a wire grid polarizer.

15. The liquid crystal display device of claim 1, wherein at least one of the plurality of light emitting element packages comprises a light emitting element configured to emit blue light,
wherein the color conversion layer comprises a first quantum dot configured to emit green light in response to being excited by the blue light and a second quantum dot configured to emit red light in response to being excited by the blue light.

16. The liquid crystal display device of claim 1, wherein at least one of the plurality of light emitting element packages further comprises a light emitting element configured to emit blue light and a sealing part covering the light emitting element and including at least one phosphor.

17. The liquid crystal display device of claim 16, wherein the sealing part comprises a first phosphor configured to emit red light in response to being excited by the blue light, and
wherein the color conversion layer comprises a first quantum dot configured to emit green light in response to being excited by the blue light.

18. The liquid crystal display device of claim 16, wherein the sealing part comprises a second phosphor configured to emit green light in response to being excited by the blue light, and
wherein the color conversion layer comprises a second quantum dot configured to emit red light in response to being excited by the blue light.

19. A liquid crystal display device comprising:
a liquid crystal display panel including a first substrate, a second substrate facing the first substrate, and a liquid crystal layer disposed between the first substrate and the second substrate; and
a light source member disposed on a lower side of the liquid crystal display panel, the light source member configured to provide first color light to the liquid crystal display panel,
wherein the first substrate comprises:
a first base substrate;
a color conversion layer disposed on an upper side of the first base substrate and including a quantum dot;
a first polarizing layer disposed on an upper side of the color conversion layer; and
a scattering layer disposed on an upper side or a lower side of the first base substrate, and
wherein the second substrate comprises:
a second base substrate;
a circuit layer disposed on a lower side of the second base substrate;
a color filter layer disposed between the liquid crystal layer and the circuit layer; and
a second polarizing layer disposed on an upper side of the second base substrate.

20. The liquid crystal display device of claim 19, wherein the first color light has a center wavelength of 420 nm to 470 nm,
wherein the color conversion layer comprises:
a first quantum dot configured to emit second color light having a center wavelength of 520 nm to 570 nm in response to being excited by the first color light; and
a second quantum dot configured to emit a third color light of a center wavelength of 620 nm to 670 nm in response to being excited by the first color light.
